(19) United States
(12) Patent Application Publication
(10) Pub. No.: US 2007/0051529 A1
(43) Pub. Date: Mar. 8, 2007

(54) Programming template for a control device

(76) Inventors: Paul Soccoli, New Hyde Park, NY (US); Danilo F. Estanislao, Old Bridge, NJ (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/367,934

(22) Filed: Mar. 3, 2006

Related U.S. Application Data
(60) Provisional application No. 60/658,263, filed on Mar. 3, 2005.

(51) Int. Cl. H02G 3/14

(52) U.S. Cl. 174/66

(57) ABSTRACT

A wallplate for an electrical device includes instructions for operating the device. The wallplate may be mounted over the device with either a first surface or a second surface visible to a user The first surface is a finished surface and is intended ordinarily to be visible. The wallplate is reversible in that it also may be mounted with the second surface visible to the user. The second surface can have instructions for operating the device. The instructions also may be positioned to appropriately label actuators of the device or can have arrows pointing to actuators and describing such actuators.

This application claims the benefit of the filing date of a provisional application having Ser. No. 63/658,263 which was filed on Mar. 3, 2005.

### BACKGROUND

1. Field of the Disclosure

The present disclosure relates to covers for control devices.

2. Description of the Related Art

Lighting controls for the home may be more complex than an on/off switch or dimmer. Modern lighting controls can fit into a standard electrical junction outlet box, or wallbox, and may include controls for lamp timers and memory of a default brightness setting when the lamp is first turned on. The outlet box with the lighting controls can be covered with a wallplate. The additional features may each require instructions for setting the control features.

As wallbox lighting controls become more and more complex, it can be difficult for a user to know how to use, install and configure the lighting controls to make use of these features. An instruction manual may be provided. Instructions in the manual may be used by both the installer of the control device and the user to understand and use features of the control device including the programming sequence, the function of each button and the meaning of any indicators. After the installation of the control device, the instruction manual may be kept for future use. The user may have no means of knowing how to program the control device if the instruction manual is misplaced or lost. Because the use of the control device can depend greatly on the preferences of the user, the user may need to program the device. Also, the user often may not be able to contact the manufacturer, so it can be difficult to gain copies of the instruction manual.

It may be convenient to the user to provide instructions on the control device. However, control devices may be limited in their overall size, so there may not enough room for instructions. When the control device is mounted in the wall, there is a very small area that may be visible to the user. It may also not be desirable to disturb the appearance or the aesthetics of the control device by providing pictures or text on the visible surface.

### SUMMARY OF THE DISCLOSURE

This invention uses the cover or wallplate associated with an electrical device to provide information such as instructions related to the device. A wallplate is installed over the device so that only the user accessible portion of the device is visible to a user. The reverse side of the wallplate can be used to place information such as instructions for operating the device. By removing the wallplate, flipping it over, and placing it over the device, in effect, placing it on backwards, the user now has a template which has instructions for programming the control device.

The wallplate of the present disclosure may include one or more of the following advantages. Because the device has a wallplate installed with it, the user will have access to the instructions on the reverse side. This can provide an increased surface area of the device to allow room for detailed instructions. An installer of the device can coordinate the text in the instruction manual to that on the device cover mounted on the wall. The instructions are visible when needed, but not visible at other times.

Other features of the disclosure will be pointed out in the following description and claims and illustrated in the accompanying drawings, which disclose, by way of example, the principles of the disclosure, and the best mode, which is presently contemplated for carrying them out.

### BRIEF DESCRIPTION OF THE DRAWINGS

For a more complete understanding of the present invention and the advantages thereof, reference is now made to the following description taken in conjunction with the accompanying drawings in which like reference numbers indicate like features and wherein:

FIG. 1 is a block diagram of method of providing instructions on a reversible cover of an electrical device.

FIGS. 2A-2B are illustrations of a cover in accordance with an embodiment of the present invention.

FIG. 3 is an illustration of the cover mounted on the device with the second surface exposed.

FIG. 4 is an illustration of a control device with a cover mounted for normal use.

### DETAILED DESCRIPTION

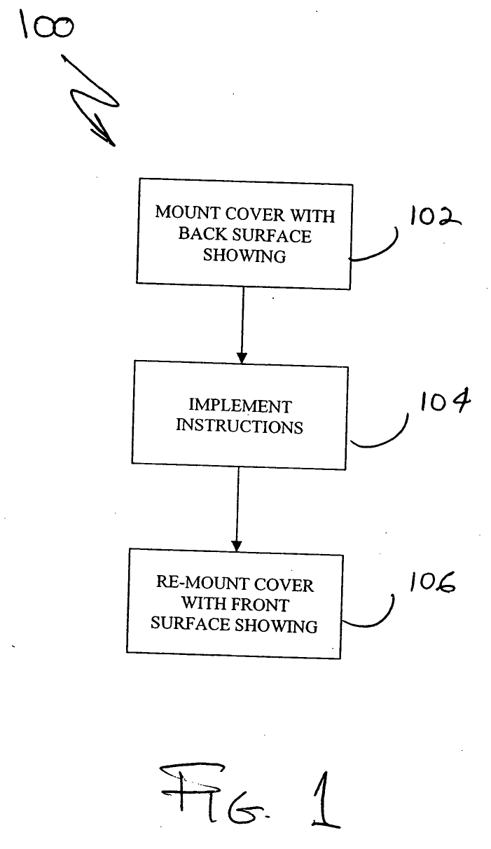

FIG. 1 is a block diagram illustrating a method 100 for programming an electrical control device. In an implementation, the control device is a dimmer for adjusting the brightness of a lighting circuit in a home. The control device can be mounted in a wall in a standard electrical box. A wallplate or cover may be supplied with the control device to cover the electrical box and provide a finished appearance to the control device. The wallplate has a first surface and a second surface and can be mounted over the control device with either surface visible or exposed to a user. The first surface is normally exposed and provides the finished look to the installed control device. In step 102, the wallplate is mounted to the control device with the second surface exposed. Instructions for operating/programming the control device can be located on the second surface. In step 104, the user can implement the desired instructions. In step 106, once the instructions are completed, the user may remove and remount the wallplate with the first surface exposed.

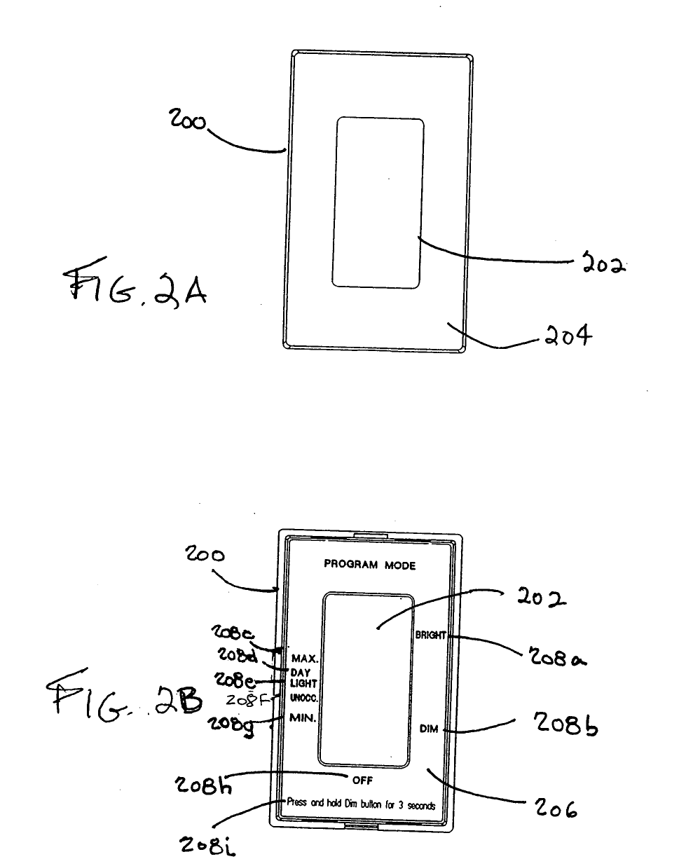

FIGS. 2A-2B are front and rear views, respectively, of an implementation of a cover 200 for a control device. Referring to FIG. 2A, in the implementation illustrated, the cover 200 is a single-gang wallplate. The cover 200 or wallplate may have an opening 202 to provide access to a control device (not shown). The wallplate 200 may be mounted to the control device by known attachment means including, but not limited to, snap fit, press fit, magnetic or mechanically mounted by screws or other hardware devices so that a first surface 204 is exposed. Referring to FIG. 2B, shown is rear view of the cover 200 for a control device illustrated in FIG. 2A. The wallplate 200 can be mounted to the control device using known attachment means as mentioned above so that a second surface 206 is exposed. The wallplate 200 may be positioned with respect to the control device with either the first surface 204 exposed or the second surface 206 exposed. The second surface 206 may include information such as instructions 208a-208i, for example, to aid a user in the operation, usage, features, button function or programming of the control device. The instructions may be provided on the second surface by molding, stenciling, etching, printing, embossing, labeling or any suitable means. The instructions may be advantageously positioned on the rear surface so as to align with actuators of the control device to instruct a user on how to operate such actuators. The instructions also can include indicators such as arrows pointing to user actuators on the control device and describing the function of such actuators, list programming steps, describe how to enter the program mode, or other appropriate information.

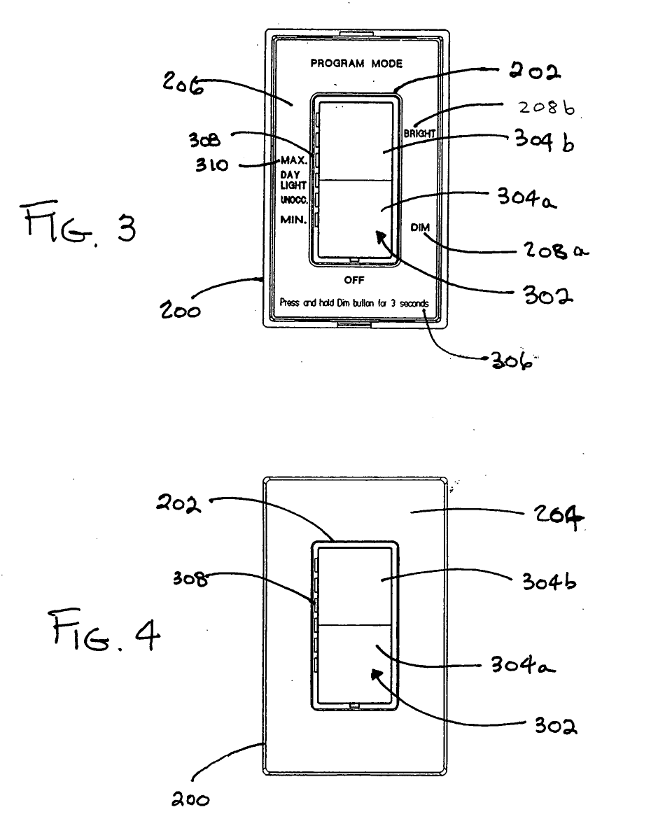

FIG. 3 illustrates the wall plate 200 of FIG. 2B disposed over a control device 302 with the second surface 206 of the wall plate exposed. The opening 202 can provide access to the control device 302. The control device 302 may have actuators to operate and program the features of the device. For example, the device may be a dimmer that has a switch with an upper actuator 304a and lower actuator 304b to dim or brighten an attached lamp (not shown). The second surface 206 may provide instructions 208a, 208b to indicate the function of the respective switch actuators 304a, 304b. Additional instructions 306 can be provided for additional functionality. The control device 302 can include buttons 308 for programming the control device. The second surface 206 can include nomenclature to help a user determine a corresponding function 310 or usage of each button without the necessity of having a separate instruction manual.

FIG. 4 illustrates the wall plate 200 of FIG. 2A disposed over the control device 302 with the first surface 204 exposed. The opening 202 can provide access to the control device. The first surface 204 may not include the nomenclature as included on the second surface. The switches actuators 304a, 304b and buttons 308 can be accessible through the opening 202. The first surface of the cover can provide a finished look to the control device.

While there have been shown and described and pointed out the fundamental features of the invention as applied to the preferred embodiment, as is presently contemplated for carrying them out, it will be understood that various omissions and substitutions and changes in the form and details of the device described and illustrated and in its operation may be made by those skilled in the art, without departing from the spirit of the invention.

What is claimed is:

1. A cover plate comprising:
a reversible cover having a first surface and a second surface and configured for mounting on a device with either the first or second surface facing away from the device,
wherein the second surface includes instructions for using the device.

2. The cover plate of claim 1, wherein the instructions align with actuators of the device to which the instructions provide information.

3. The cover plate of claim 1, wherein the instructions have arrows pointing to actuators on the device and describing the function and/or use of the actuators.

4. The cover plate of claim 1, wherein the instructions are on a label affixed to the second surface.

5. The cover plate of claim 1, wherein the instructions are an integral part of the second surface.

6. The cover plate of claim 5, wherein the instructions are on the second surface using placement techniques includes at least one of molded, stenciled, etched, printed, embossed and labeled.

7. The cover plate of claim 1 wherein the reversible cover has an opening which allows a user accessible portion of the device to be visible.

8. The cover plate of claim 1 wherein the device is a dimmer for adjusting the brightness of a light.

9. The cover plate of claim 1 wherein the reversible cover has an attachment means for detachably coupling to the device.

10. A method of providing instructions for using a control device comprising:
providing a cover for the control device that can be mounted on the device with either a first surface or second surface of the cover facing away from the device; and
providing instructions for using the control device on the second surface of the cover.

11. A method of programming a device comprising:
mounting a cover on the device with a second surface of the cover visible to a user, wherein the second surface includes instructions for using the device;
implementing the instructions as necessary to use the device;
removing the cover; and
remounting the cover with a first surface visible to the user.
